(19) United States
(12) Patent Application Publication
(10) Pub. No.: US 2003/0104127 A1
(43) Pub. Date: Jun. 5, 2003

(54) Decorative stamp painting system

(76) Inventors: Samuel E. Katzen, Berkeley, CA (US); Ronald A. La Rosa, Yorba Linda, CA (US)

Correspondence Address: MATTHEW A. NEWBOLES, 75 ENTERPRISE, SUITE 250, ALISO VIEJO, CA, 92656, US

(21) Appl. No.: 09/998,089

(22) Filed: Nov. 30, 2001

(51) Int. Cl. B05D 1/28; B05D 5/00

(52) U.S. Cl. 427/256; 427/428; 101/405; 101/368

(57) ABSTRACT

A system and method for painting decorative designs. According to a preferred embodiment, the invention comprises an imprint applicator handle including a handle member and imprint applicator, the latter preferably comprising a generally rectangular, arcuate member formed from a clear or non-opaque material. The imprint applicator defines an arcuate application surface to which a rubber stamp design may be detachably fastened. The rubber stamp design is adapted to receive a pigment, which may be a paint, ink, or dye and when rocked across a substrate, such as a wall, paper and the like, via the imprint applicator handle, the pigment is caused to transfer from the rubber stamp design to the substrate. Advantageously, the present invention enables a wide variety of designs to be easily and neatly formed, as well as capable of being faithfully duplicated.

### CROSS-REFERENCE TO RELATED APPLICATIONS

(Not Applicable)

### STATEMENT RE: FEDERALLY SPONSORED RESEARCH/DEVELOPMENT

(Not Applicable)

### BACKGROUND OF THE INVENTION

Decorative painting of designs is well-known in the art. In this regard, the addition of decorative painted or stamped designs can and is frequently employed to add color and enhance interior decor. Indeed, decorative painting has wide-spread application for both commercial and residential properties and, with respect to the latter, can be utilized to enhance the beauty and theme of a given room, whether it be a nursery, kitchen, game room, bathroom and the like.

Decorative painting/stamping further has wide-spread application in the fields of arts and crafts and signage. In this respect, decorative painting can and frequently does serve to draw attention and enhance the appearance of a wide variety of items, such as banners and the like. Such activity is also quite fun and enjoyable for both adults and children.

Notwithstanding its wide-spread appeal and usefulness, it is frequently difficult, if not impossible, for the average lay person to make painted designs, let alone reliably reproduce such designs for a given application, whether it would be interior decor, arts and crafts, or any other application where it is desired to utilize such artwork. In this regard, most individuals lack the requisite artistic ability to paint such designs, let alone reliably reproduce a given design as may be desired for a given application, such as a boarder extending around the walls of a room. While stamping and sponge-like systems are available that attempts to enable the average lay person to consistently reproduce a given painted design, such systems do not enable the person to uniformly replicate such design. For example, it is well-known that such systems, if not utilized precisely, can cause a tremendous variation from design to design, and can further promote dripping and smudging by virtue of the non-uniform manner by which the painted design is applied to a wall or other substrate. In this respect, such systems require the user to simply press the design against a wall or other substrate and do not enable the painted design to uniformly transfer onto the surface. Moreover, such systems typically do not provide the user with an accurate mechanism by which the user can determine where the painted design will be placed and appear on a wall or substrate.

By virtue of the lack of such systems that can enable decorative designs to be repeatedly and reliably painted upon a wall, numerous drawbacks consequently exist. Firstly, in light of the lack of such available systems, professional painters and artists typically must be hired to paint a given decorative design pattern, which can be at substantial expense and can be time consuming. Alternatively, to the extent prior art systems are utilized, user error can produce sloppy or inconsistent paintings, and substantial effort and expense will be required in clean-up and re-painting. Accordingly, there is a substantial need in the art for a system and method by which decorative patterns can be quickly, easily and accurately painted upon a given surface, such as a wall and the like, with a high level of uniform reproducibility. There is further a substantial need in the art for such a system and method that is of simple design, inexpensive to manufacture and can be readily utilized using existing materials and paint supplies. There is still further a need for such a system that is safe, fun, fast and more efficient and effective in reproducibly painting decorative images than prior art systems and methods.

### BRIEF SUMMARY OF THE INVENTION

The present invention specifically addresses and alleviates the above-identified efficiencies in the art. In this regard, the present invention is directed to a decorative stamp painting system for easily, quickly and accurately painting a desired decorative image on a given substrate, such as a wall, banner, or any other surface upon which a decorative painting may be painted. According to a preferred embodiment, the invention comprises an imprint applicator handle comprised of a handle member and imprint applicator, the latter of which preferably comprises an arcuate, generally rectangular member formed from a non-opaque, and preferably clear material such as plastic or glass. The imprint applicator further is preferably includes grid indicia formed thereon to facilitate the accurate placement and painting of a given decorative design. The bottom surface of the imprint applicator is configured to releasably engage with a rubber stamp design, the latter of which may take any of a variety of forms, and preferably included those produced by Rubber Stampede, Inc. of Whittier, Calif. In this regard, such stamps will come in a wide variety of designs and themes as may be desired for a given application, as well as to suit a variety of individual preferences.

The stamp design will be securely fastened to the imprint applicator such that the same is bound thereto and assumes a complimentary arcuate configuration. To properly orient and position such rubber stamp, the grid system formed upon the imprint applicator may be used to reference placement of specific points of the rubber stamp design. Once so interconnected, a layer or coat of paint is applied to the rubber stamp design. The handle portion of the imprint applicator handle is manually grasped and the rubber stamp design with paint thereon is rolled across the target surface sought to be painted with the design. In this regard, due to the arcuate nature of the imprint applicator of the imprint applicator handle, the user is thus able to easily and accurately paint or stamp a desired design a precise orientation at a selected site. By virtue of the roll-on application of the design, the resultant painted design will typically appear evenly distributed and not drip or otherwise look uneven, as frequently occurs with prior art systems.

The system of the present invention can be repeatedly used to make repeating design patterns, or can be utilized to make combinations of designs. The system is further designed for easy clean-up and capable of being utilized with virtually all types of paints, and in particular water-based paints such as those produced by Delta Technical Coatings of Whittier, Calif.

It therefore an object of the present invention to provide a system and method for painting decorative designs that is easy to use, of simple construction, and can accurately paint a desired image at a selected site with great accuracy.

Another object of the present invention to provide a system and method that enables a desired design to be repeatedly painted at a variety of selected sites with a higher degree of uniformity in appearance than prior art systems and methods.

Another object of the present invention is to provide a system and method that is less messy, causes less running and produces superior looking paintings than decorative design painting made by prior art systems and methods.

Still further, the present invention provides a system and method that is inexpensive to utilize, may be utilized by virtually everyone, can be utilized to paint decorative designs in a wide variety of contexts, whether it be for interior decor, arts and crafts, or any other wide variety of purposes, is fun to utilize, and can be utilized to paint virtually any type of decorative designs with virtually any and all types of paint.

### BRIEF DESCRIPTION OF THE DRAWINGS

These, as well as other features of the present invention, will become more apparent upon reference to the drawings wherein:

FIG. 1 is an elevated, perspective view of an imprint applicator handle constructed in accordance with a preferred embodiment of the present invention for use in painting decorative designs.

FIG. 2 is a perspective view of a rubber stamp design being applied to the arcuate application surface of the imprint applicator handle of FIG. 1, said rubber stamp design taking the form a leaf pattern.

FIG. 3 is perspective illustration of the rubber stamp design of FIG. 2 as affixed to the arcuate application surface of the imprint applicator handle further illustrating a user applying a coat of paint thereto via a conventional paint roller.

FIG. 4 is perspective view of the system of the present invention as utilized to paint the leaf pattern design at a selected site upon a substrate.

### DETAILED DESCRIPTION OF THE INVENTION

The detailed description set forth below is intended as a description of the presently preferred embodiment of the invention, and is not intended to represent the only form in which the present invention may be constructed or utilized. The description sets forth the functions and sequences of steps for constructing and operating the invention. It is to be understood, however, that the same or equivalent functions and sequences may be accomplished by different embodiments and that they are also intended to be encompassed within the scope of the invention.

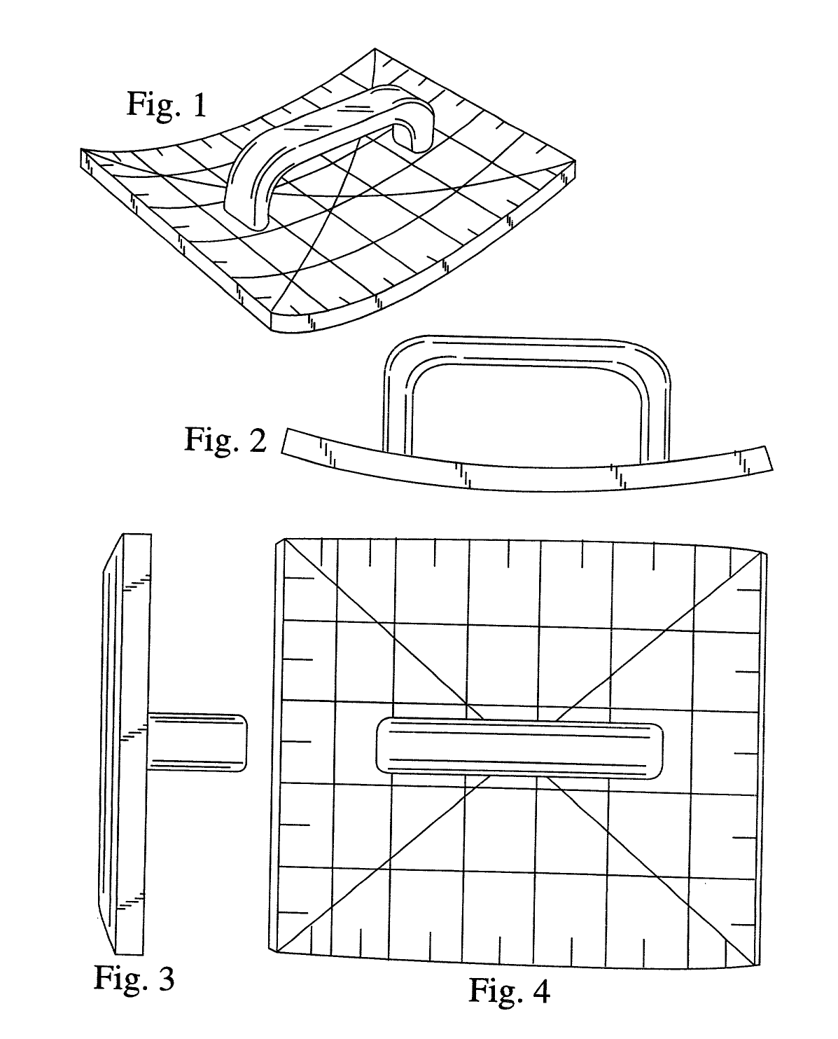

Referring now to the drawings, and initially to FIG. 1, there is perspectively illustrated a system 10 for use in painting a decorative design in a quick and reliable manner that faithfully reproduces uniform paintings of a particular design. In this respect, the system 10 of the present invention is specifically designed and adapted for use in painting or stamping decorative designs, and is particularly useful in arts and crafts applications, as well as interior/exterior decor applications. It should be understood, however, that the present invention may have wide spread applicability in a variety of fields and need not be limited to the particular applications referenced herein.

As illustrated, the system 10 comprises an imprint applicator handle consisting of a handle member 12 affixed to an imprint applicator 14. With respect to the latter, the imprint applicator 14 preferably comprises a rigid rectangular member that is formed to have a generally arcuate shape. The imprint applicator 14 is further preferably formed to be clear or otherwise formed from a non-opaque material to facilitate the user's ability to accurately paint a decorative design at a given location. Accordingly, the applicator 14 will preferably be formed from a clear material such as glass, or more preferably plastic to thus minimize the susceptibility the handle has to breakage.

To further facilitate the ability of the imprint applicator handle to accurately paint a given design at a target site, there is preferably formed on the imprint applicator 14 indicia 16, 18. As illustrated, such indicia may take the form of a grid system 16, or include diagonally-extending cross-hairs 18 to thus enable the user to precisely apply a painted design at a given position and orientation, discussed more fully below.

The imprint applicator handle, and more particularly the imprint applicator 14 thereof, is provided with an arcuate application surface 20 which, as discussed more fully below, is operative to receive a given rubber stamp design and facilitate the ability thereof to apply the painted design pattern at a target site. To achieve that end, there is illustrated in FIG. 2 a leaf design 22 secured to the arcuate application surface 20 of imprint applicator 14. As illustrated, the rubber stamp design 22 may be manually secured into position upon the arcuate application surface 20. To allow for such interconnection, such rubber stamp design 22 can be affixed thereto by any of a variety of mechanical or adhesive means well-known in the art. In one particular embodiment, design 22 will include a vinyl backing (not shown) that cooperates with the arcuate application surface to securely interconnect the two to one another. In this regard, it is contemplated that the rubber stamp design may take any of a wide-variety of designs offered by Delta Technical Coatings of Whittier, Calif. Along these lines, it should be expressly recognized that the rubber stamp design 22, although depicted as a leaf, may take virtually any type of design available, whether it be a simple geometric design, cartoon character, sports theme, or any of a virtually limitless variety of designs to thus enable individual users to choose a design according to a given preference.

Once the rubber stamp design 22 has been secured to the arcuate application surface 20 in the manner shown in FIG. 2, the rubber stamp 22 is then coated with a layer of paint, as depicted in FIG. 3. As illustrated, while the user holds the imprint applicator handle via handle member 12 (not shown), the user with the other free hand 24 can roll a layer or coat of paint 30 upon the rubber stamp 22. By virtue of the secure interconnection between the stamp 22 and arcuate application surface 20, the rubber stamp 22 will be maintained in secure orientation to thus enable the paint to be applied thereto. To that end, it is contemplated that the most efficient manner by which paint may be applied is through a conventional paint roller 28 with paint roll 26 attached thereto, which are well-known in the art and commercially-available in virtually all hardware and paint stores.

Once the rubber stamp design 22 has been sufficiently coated the layer of paint 30, the user may selectively print or stamp the painted rubber stamp design upon a given substrate, such as 32 depicted in FIG. 4. As illustrated, the substrate 32 may comprise virtually any type of paintable surface, whether it would be a wall or ceiling, as in the case of interior decor, or a piece of poster board or banner as would be deployed in arts and crafts applications. Once a desired site is selected at which the design is to be painted, the user need only downwardly compress the imprint applicator handle in the manner indicated by the letter B such that a respective end of the imprint applicator compresses the painted rubber stamp against the substrate 32. The imprint applicator handle is thereafter rocked back and forth in the direction indicated by the letter C such that the painted rubber stamp design transfers the paint thereon, and hence the design on the substrate 32 at a selected site thereof. To facilitate the user's ability to accurately target the site to be painted, the indicia 16, 18, may be utilized to help align the painted rubber stamp with the target site to be painted on substrate 32.

When so applied, a design imprint, such as 34, will be made. Advantageously, such design imprint is capable of being made in a manner that is simple and easy, and need only require the user to roll such design at the target site to make a desired imprint. Unlike prior art systems, the arcuate imprint applicator merely requires a rolling motion, as opposed to a purely linear stamping or blotting motion, which consequently causes the paint spread upon the design to distribute more evenly and create a fuller, more uniformly-reproducible design than prior art systems and methods.

As will appreciated, the system of the present invention can be utilized with virtually any and all types of paints, including both oil and water-based paints. Due to their ease in clean-up and lesser toxicity, it is contemplated that water-based paints may be easier to work with and to practice of the present invention. It should be understood, however, that the present invention need not be limited to paints, but that inks or other dyes may be utilized to make the desired design imprint. It will be further recognized that although depicted for use by a single hand of an individual, the imprint applicator handle may be enlarged to be utilized by two hands, to thus imprint larger designs, or, alternatively, made smaller, to thus accommodate smaller designs, and/or allow children or individuals with smaller hands to make decorative stamp designs.

Although the invention has been described here and with specific reference to a presently preferred embodiment thereof, it would be appreciated by those skilled in the art that various modifications, deletions, and alterations, maybe made to such preferred embodiment without departing from the spirit and scope of the invention. For example, although the arcuate application surface 20 is depicted as being generally convex, the same may also be concave in nature to the extent it is necessary to form decorative designs on an arcuate surface. In this respect, it is contemplated that the application surface may be selectively contoured to thus enable a decorative design to be painted upon a reciprocal-shaped surface. Accordingly, it is intended that all suitable modifications and equivalents be deemed as falling within the scope of the invention.

1. A system for painting a decorative design upon a substrate comprising:
a) an imprint applicator handle having a manually graspable surface and an arcuate application surface;
b) a stamp formed upon said arcuate application surface; and
c) wherein when said stamp is painted, said arcuate application surface may be manually rolled across the surface of the substrate to transfer the painted stamp design onto said substrate.

2. The system of claim 1 wherein said stamp comprises a rubber stamp design detachably fastenable to said arcuate application surface of said imprint applicator handle.

3. The system of claim 1 wherein said imprint applicator handle includes a handle member.

4. The system of claim 1 wherein said imprint applicator handle is formed from a clear or non-opaque material.

5. The system of claim 5 the system of claim 4 wherein said imprint application handle is fabricated from a material selected from the group consisting of glass and plastic.

6. The system of claim 2 wherein said imprint applicator handle has indicia formed thereon for facilitating the placement of said stamp upon the arcuate application surface thereof, and to facilitate application of the painted design on the substrate.

7. A system for imprinting a painted design upon a substrate comprising:
a) an imprint applicator having a handle affixed thereto, said imprint applicator having an arcuate application surface;
b) a rubber stamp detachably fastenable to said arcuate application surface, said rubber stamp being formed to have a decorative design and receive a pigment thereon; and
c) wherein when said arcuate application surface is compressively rocked against said substrate, said pigmented stamp is operative to form a design imprint thereon.

8. The system of claim 7 wherein said imprint applicator comprises a generally rectangular member having a bowed, arcuate configuration.

9. The system of claim 7 wherein said imprint applicator includes indicia thereon for facilitating attachment of said rubber stamp and contacting said pigmented rubber stamp to said substrate.

10. The system of claim 7 wherein said pigment received upon said rubber stamp is selected from the group consisting of a paint, an ink, and a dye.

11. A method of forming a decorative design upon a substrate comprising the steps:
a) providing an imprint applicator handle, said imprint applicator handle consisting of a manually graspable surface and an arcuate application surface;
b) providing a stamp design;
c) affixing the stamp design to the arcuate application surface of the imprint applicator handle;
d) applying a pigment to the rubber stamp design; and
e) compressively rolling the arcuate application surface of the imprint applicator handle upon said substrate sufficient to transfer the dye from the rubber stamp to said substrate.

12. The method of claim 11 wherein in step d), said pigment is selected from a group consisting of a paint, an ink, and a dye.

13. The method of claim 11 wherein in step e), said imprint applicator handle is rocked such that the arcuate application surface facilitates contact between the rubber stamp and substrate.

14. The method of claim 12 wherein in step a), said imprint applicator handle includes a handle member and an imprint applicator, said imprint applicator defining said arcuate application surface for receiving said stamp.

15. A method for forming a painted stamp design upon a substrate comprising the steps:
a) providing an imprint application handle, said imprint application handle being comprised of a handle member and an imprint applicator, said imprint applicator having a generally rectangular, arcuate shape and defining an arcuate application surface;
b) affixing a rubber stamp design to said arcuate application surface such that said stamp assumes a generally arcuate configuration;
c) applying a pigment to said rubber stamp design, said pigment being selected from the group consisting of a paint, an ink and a dye; and
d) operatively manipulating said handle member of said imprint applicator handle to transfer the pigment formed upon said rubber stamp design at a select target upon said substrate.

16. The method of claim 15 wherein in step a), said imprint applicator of said imprint applicator handle includes indicia formed thereon for facilitating attachment of said rubber stamp designed thereto, and imparting said pigment from said rubber stamp to said substrate.
